(19) United States
(12) Patent Application Publication
(10) Pub. No.: US 2016/0020965 A1
(43) Pub. Date: Jan. 21, 2016

(54) METHOD AND APPARATUS FOR DYNAMIC MONITORING CONDITION CONTROL

(71) Applicant: HITACHI, LTD., Tokyo (JP)

(72) Inventors: Masayuki SAKATA, Kirkland, WA (US); Ning LIAO, Sammamish, WA (US); Arno GRBAC, Bellevue, WA (US)

(21) Appl. No.: 14/774,094

(22) PCT Filed: Aug. 7, 2013
(86) PCT No.: PCT/US13/54021

§ 371 Date: Sep. 9, 2015

(51) Int. Cl. H04L 12/26; G06F 11/20

(52) U.S. Cl. CPC H04L 43/04; G06F 11/2033; G06F 2201/805

(57) ABSTRACT

Example implementations described herein are directed to predict the target elements that could be potentially affected by operations and incidents for one or more computer systems involving a server, a network and a storage system, by using topology information and redundant technology information. Example implementations described herein are further directed to changing the monitoring condition of the elements for some period of time and correlate elements, events, and monitored data to help the administrator to analyze impact of the event.

### BACKGROUND

1. Field

The example implementations relate to a computer system having a host computer, a storage subsystem, a network system, and a management computer; and, more particularly, to a technique for monitoring performance of the computer system.

2. Related Art

With the spread of Information Technology (IT), there has been rapid progress in the size and complexity of computer systems. For management software to monitor the performance of computer systems having such size and complexity, there has been a need to monitor a larger number of monitoring targets, and at a higher precision. This monitoring causes several issues: (1) it may become more difficult to collect every item at a high sampling rate, because the collection of items affects the central processing unit (CPU), memory, network bandwidth and storage size of the monitoring system, and (2) it may become more difficult to change sampling rate and metrics dynamically because related art monitoring systems do not determine when, which elements, which metrics, and how long to conduct the monitoring.

To improve performance of monitoring and provide monitoring for a larger number of monitoring targets at higher precision, the related art includes a method, computer and computer system for monitoring performance. For example, dynamically changing monitoring conditions may be based on the priority of the storage logical volumes or the logical volume groups.

In the related art, the performance data is utilized for troubleshooting. For troubleshooting, management software may monitor the performance of component related to the trouble. However, the related art does not identify the components related to the trouble.

### SUMMARY

There is a need for identifying of the monitoring targets to be monitored at higher precision, and to optimize monitoring conditions. The example implementations described herein provide for the automatic identification of the area to be monitored.

Aspects of the example implementations may involve a computer program, which may involve a code for managing a server, a switch, and a storage system storing data sent from the server via the switch; a code for calculating a plurality of elements among a plurality of element types, the plurality of elements including an element of at least one of the server, the switch and the storage system that can be affected by an event; a code for calculating a condition for monitoring the calculated elements; and a code for initiating monitoring of the calculated elements based on the calculated condition. The computer program may be in the form of instructions stored on a memory, which may be in the form computer readable storage medium as described below. Alternatively, the instructions may also be stored on a computer readable signal medium as described below.

Aspects of the example implementations may involve a computer that has a processor, configured to manage a server, a switch, and a storage system storing data sent from the server via the switch; calculate a plurality of elements among a plurality of element types, the plurality of elements including an element of at least one of the server, the switch and the storage system that can be affected by an event; calculate a condition for monitoring the calculated elements; and initiate monitoring of the calculated elements based on the calculated condition. The computer may be in the form of a management server/computer as described below.

Aspects of the example implementations may involve a system, that includes a server; a switch; a storage system; and a computer. The computer may be configured to manage the server, the switch, and the storage system storing data sent from the server via the switch; calculate a plurality of elements among a plurality of element types, the plurality of elements including an element of at least one of the server, the switch and the storage system that can be affected by an event; calculate a condition for monitoring the calculated elements; and initiate monitoring of the calculated elements based on the calculated condition.

### BRIEF DESCRIPTION OF THE DRAWINGS

FIG. 1 illustrates a computer system configuration in which the method and apparatus of the example implementation may be applied.

FIG. 2 illustrates an example of a software module configuration of the memory according to the first example implementation.

FIG. 3 illustrates an example of the System Element Table.

FIG. 4 illustrates an example of the Connectivity Table.

FIG. 5 illustrates an example of the Server Cluster Table.

FIG. 6 illustrates an example of the Teaming Configuration Table.

FIG. 7 illustrates an example of the MPIO Configuration Table.

FIG. 8 illustrates an example of the Monitoring Metrics Table.

FIG. 9 illustrates an example of the Affected Elements Table.

FIG. 10 illustrates an example of the Operation Table.

FIG. 11 illustrates an example of the Performance Data Table.

FIG. 12 is an example of the affected elements according to the first example implementation.

FIG. 13 is a flow diagram illustrating an element management operation flow as executed by the management server according to the first example implementation.

FIG. 14 illustrates an example of the created operation schedule.

FIG. 15 illustrates an example of the affected elements according to the second example implementation.

FIG. 16 illustrates a flow diagram illustrating a monitoring condition change in an element failure as executed by the management server according to the second example implementation.

FIG. 17 illustrates an example of the Event Table.

FIG. 18 illustrates an example of the performance analysis GUI.

FIG. 19 illustrates a flow diagram illustrating a performance analysis operation using the performance analysis GUI.

FIG. 20 illustrates an example of a system configuration of the third example implementation.

FIG. 21 illustrates an example of the System Element Table of the third example implementation.

FIG. 22 illustrates an example of the Connectivity Table of the third example implementation.

FIG. 23 illustrates an example of the Server Cluster Table of the third example implementation.

FIG. 24 illustrates an example of the Affected Elements Table of the third example implementation.

FIG. 25 illustrates an example of the Storage Volume Replication Table.

FIG. 26 illustrates the affected elements according to the example implementation.

FIG. 27 illustrates an example of the Performance Analysis GUI in the third example implementation.

FIGS. 28(a) and 28(b) illustrate an example of the Multiple Computer System Monitoring GUI in the third example implementation.

FIG. 29 illustrates a flow diagram illustrating a performance analysis operation using the performance analysis GUI.

FIGS. 30(a) to 30(d) illustrate an example of affected elements during a volume migration across storage systems, according to the third example implementation.

### DETAILED DESCRIPTION

The following detailed description provides further details of the figures and exemplary implementations of the present application. Reference numerals and descriptions of redundant elements between figures are omitted for clarity. Terms used throughout the description are provided as examples and are not intended to be limiting. For example, use of the term “automatic” may involve fully automatic or semi-automatic implementations involving user or administrator control over certain aspects of the implementation, depending on the desired implementation of one of ordinary skill in the art practicing implementations of the present application.

### First Example Implementation

### Performance Monitoring During Element Management Operation

The first example implementation illustrates the changing of monitoring conditions during the computer system management operation.

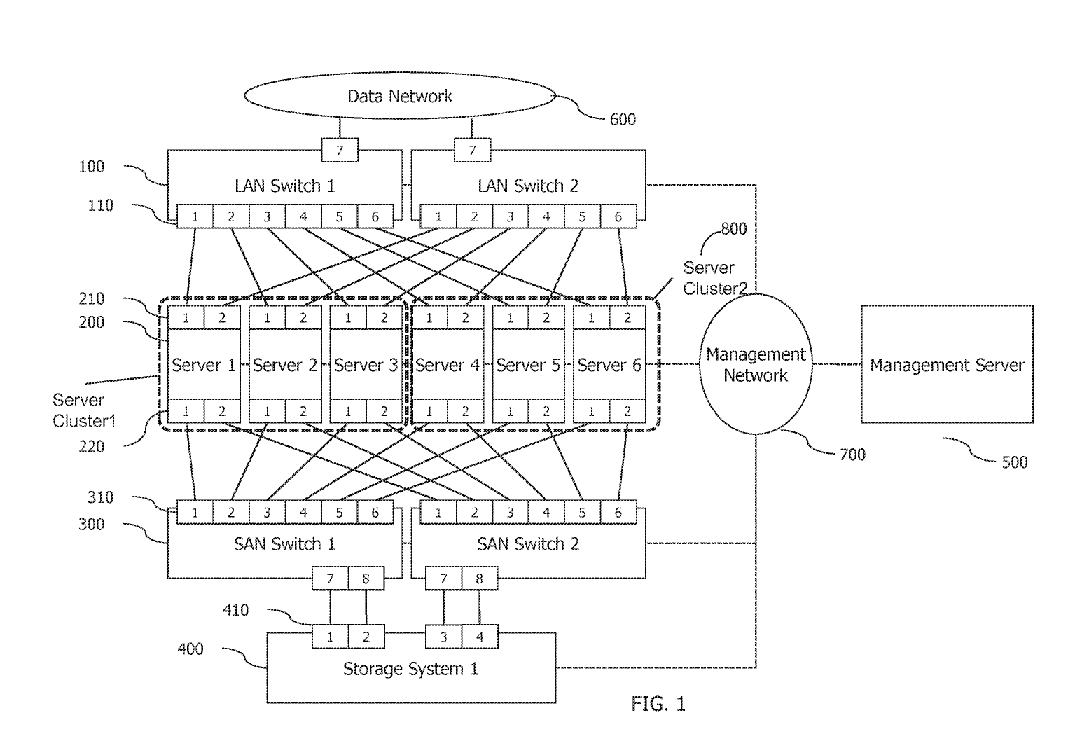

FIG. 1 illustrates a computer system configuration in which the method and apparatus of the example implementation may be applied. The configuration includes LAN (Local Area Network) switch 100, LAN switch port 110, server 200, server LAN port 210, server SAN (Storage Area Network) port 220, SAN switch 300, SAN switch port 310, storage system 400, storage port 410, management server 500, data network 600, management network 700, and one or more server clusters 800.

In this example computer configuration of a computer system, the computer system involves two LAN switches 100 (e.g., “LAN Switch 1”, “LAN Switch 2”), two SAN switches 300 (e.g., “SAN Switch 1”, “SAN Switch 2”), six servers 200 (e.g., “Server 1”, “Server 2”, “Server 3”, “Server 4”, “Server 5”, “Server 6”), one storage system 400 (e.g., “Storage System 1”) and one Management Server 500 (e.g., “Management Server”). Each server 200 has two LAN switch ports 210 and two SAN switch ports 220. Additionally, each server 200 is connected to two LAN switches 100 and two SAN switches 300 via LAN switch ports 210 and SAN switch ports 220 to improve redundancy. For example, in case “SAN Switch 1” fails, “Server 1” can keep communicating to “Storage System 1” 400 via “SAN Switch 2”.

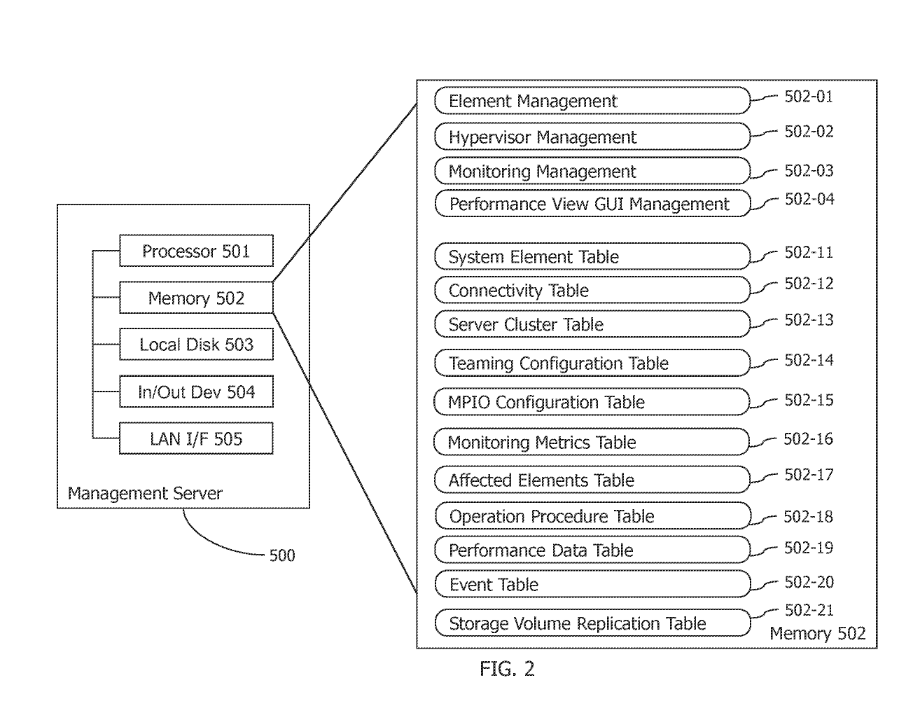

FIG. 2 illustrates a module configuration of a management server 500, which may take the form of a computer (e.g. general purpose computer), or other hardware implementations, depending on the desired implementation. Management server 500 has Processor 501, Memory 502, Local Disk 503, Input/Output Device (In/Out Dev) 504, and LAN Interface 505. In/Out Dev 504 is a user interface such as a monitor, a keyboard, and a mouse which may be used by a system administrator. Not only can Management Server 500 be implemented as a physical host, but it can also be implemented as a virtual host, such as a virtual machine.

FIG. 2 illustrates an example of a software module configuration of the memory 502 according to the first example implementation. It includes Element Management 502-01, Hypervisor Management 502-02, Monitoring Management 502-03, Performance View Graphical User Interface (GUI) Management 502-04, System Element Table 502-11, Connectivity Table 502-12, Server Cluster Table 502-13, Teaming Configuration Table 502-14, Multipath Input/Output (MPIO) Configuration Table 502-15, Monitoring Metrics Table 502-16, Affected Elements Table 502-17, Operation Procedure Table 502-18, Performance Data Table 502-19, Event Table 502-20, and Storage Volume Replication Table 502-21.

The above described software module configurations may be stored in Memory 502 in the form of a computer program executing code to implement the corresponding processes. Memory 502 may be in a form of a computer readable storage medium, which includes tangible media such as flash memory, random access memory (RAM), HDD, or the like. Alternatively, a computer readable signal medium can be used instead of Memory 502, which can be in the form of carrier waves. The Memory 502 and the Processor 501 may work in tandem to function as a controller for the management server 500.

Management server 500 communicates to other elements in the computer system and provides management functions via management network 700. For example, Element Management 502-01 maintains the System Element Table 502-11, Connectivity Table 502-12 and Operation Table 502-18 to provide system configuration information to the system administrator and execute a system management operation such as an element firmware update. Hypervisor Management 502-02 maintains the Server Cluster Table 502-13, Teaming Configuration Table 502-14, and MPIO Configuration Table 502-15 to provide hypervisor configuration information to the system administrator.

Monitoring Management 502-03 maintains monitoring related tables such as the Monitoring Metrics Table 502-16, Affected Elements Table 502-17, and Performance Data Table 502-19. Monitoring Management 502-03 collects performance data from elements and stores it into Performance Data Table 502-19. Performance View GUI Management 502-04 provides one or more views of monitoring information, such as system events related to one or more monitored elements, system topology and performance of one or more monitored elements.

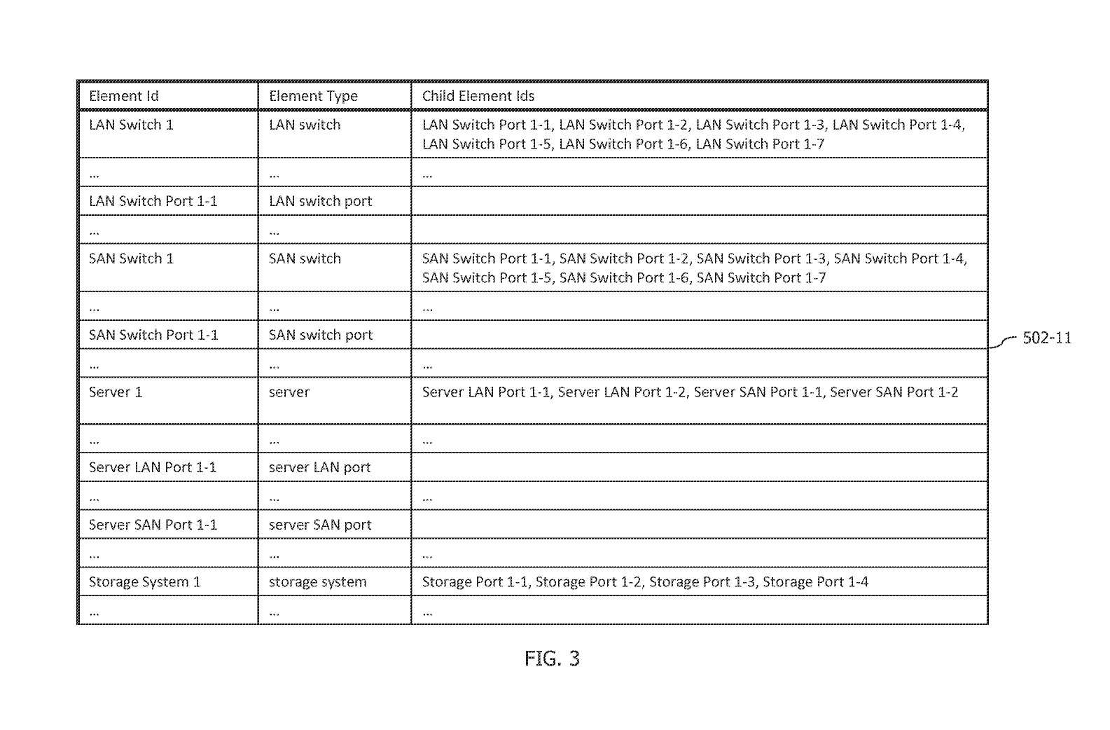

FIG. 3 illustrates an example of the System Element Table 502-11. The “Element Id” field represents the identifiers of elements which are managed by management server 500. The “Element Type” field represents the type of element. The “Child Element Ids” field represents the list of identifiers of child elements which belong to the element. For example, FIG. 3 shows that Server 1 has Server LAN Port 1-1, Server LAN Port 1-2, Server SAN Port 1-1 and Server SAN Port 1-2 as child elements.

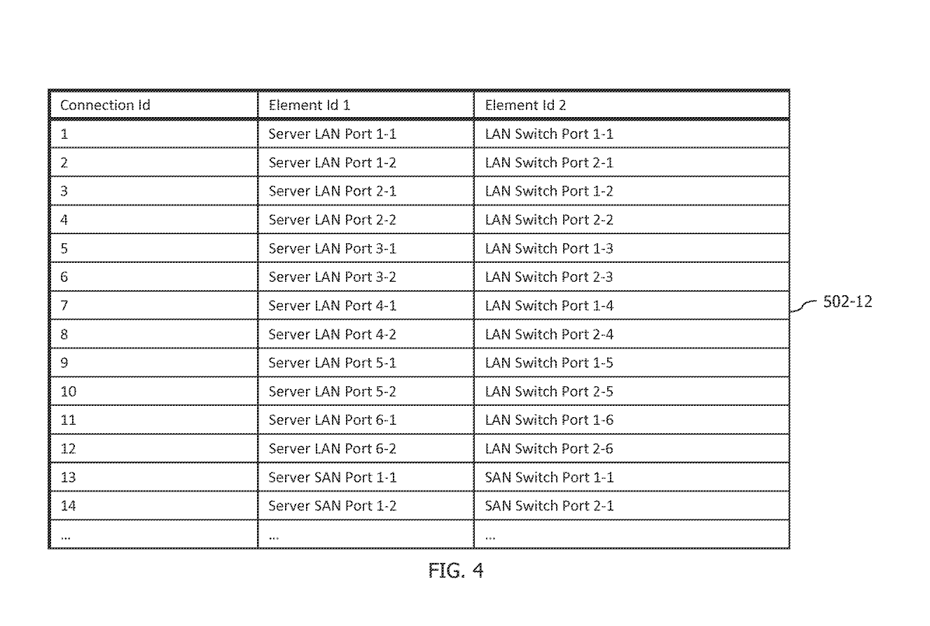

FIG. 4 illustrates an example of the Connectivity Table 502-12. This table represents the connectivity information between elements of the computer system. The “Connection Id” field represents the identifier of each connection. The “Element Id 1” and “Element Id 2” fields represent the element Ids of edge elements of each connection.

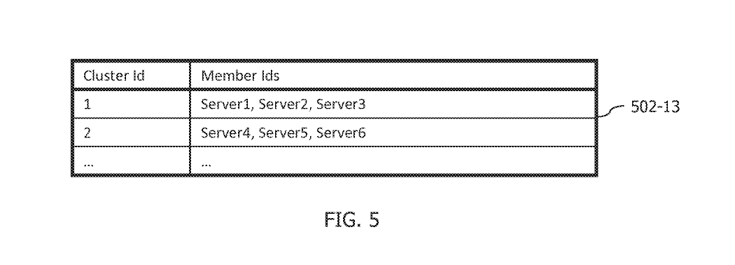

FIG. 5 illustrates an example of the Server Cluster Table 502-13. This table represents the member of server cluster group for failover. The server cluster group is a logical group of servers. The “Cluster Id” field represents the identifier of each cluster. The “Member Ids” field represents the Member server element identifier list of each cluster. In case of a server failure, other servers continue to run workloads which had been running on the failed server prior to its failure. This cluster can be implemented by any technique known to one of ordinary skill in the art.

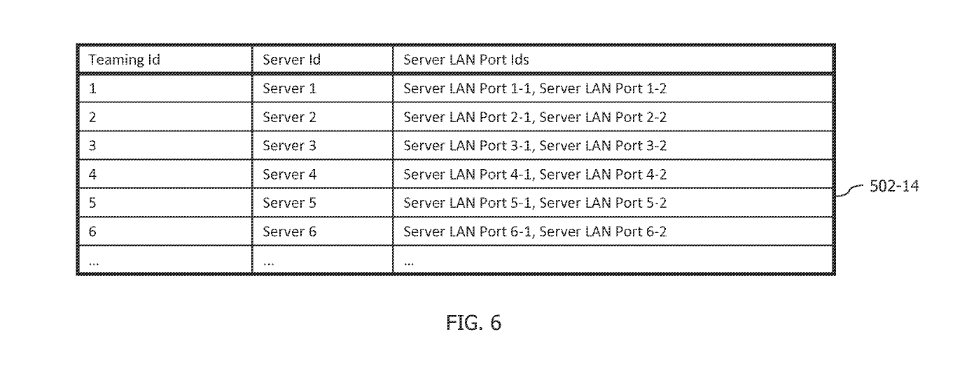

FIG. 6 illustrates an example of the Teaming Configuration Table 502-14. This table represents member ports of “teaming” on server 200. Teaming is a technique for logical grouping of LAN ports to achieve load balancing and failover across multiple LAN ports. The “Teaming Id” field represents the identifier of each teaming. The “Server Id” field represents the identifier of server 200. The “Server LAN Port Ids” field represents a list of identifier of server LAN port 210 which is a member of the teaming group.

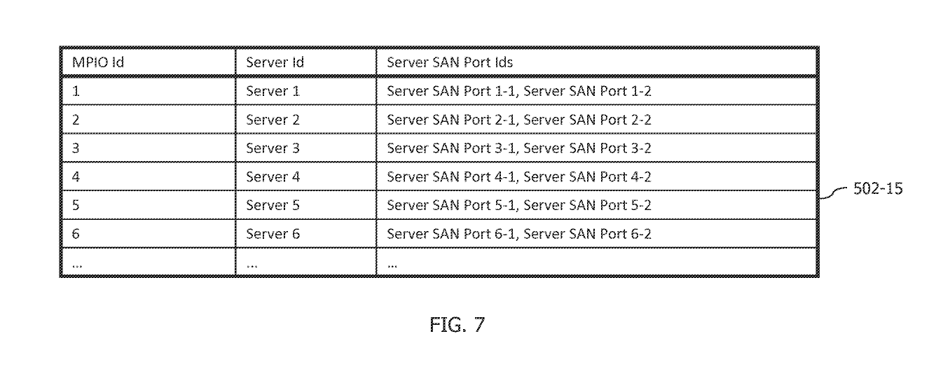

FIG. 7 illustrates an example of the MPIO Configuration Table 502-15. This table represents member ports of storage MPIO on server 200. The MPIO is a technology of logical grouping of SAN ports to achieve load balancing and failover across multiple SAN ports. The “MPIO Id” field represents the identifier of each MPIO group. The “Server Id” field represents the identifier of server 200. The “Server SAN Port Ids” field represents the list of identifier of server SAN port 210 which is a member of the MPIO group.

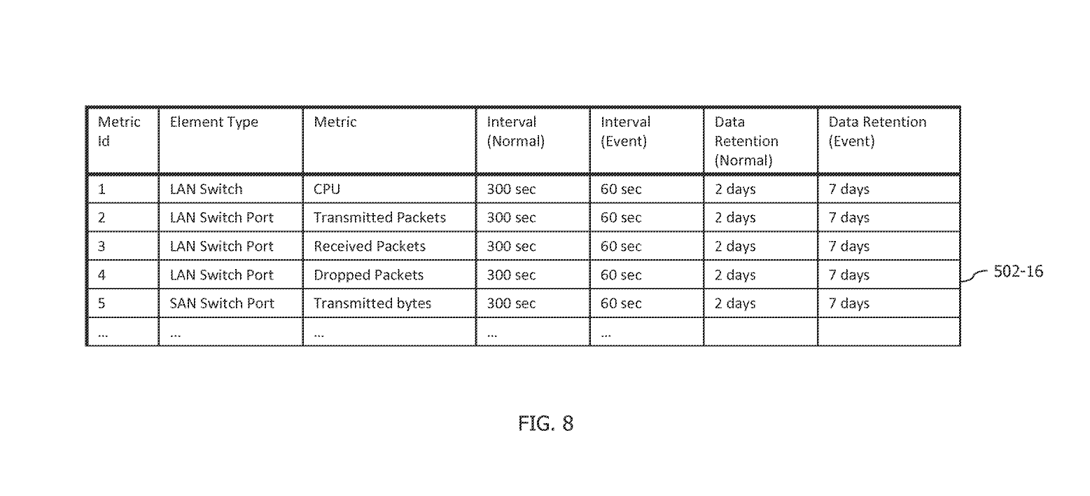

FIG. 8 illustrates an example of the Monitoring Metrics Table 502-16. The “Metric Id” field represents the identifier of each monitoring metric. The “Element Type” field represents the type of element. The “Metric” field represents the monitoring metric of each element. The “Interval (Normal)” field represents the interval of collecting the data of each metric from the elements during normal operation (e.g., no event has occurred yet). The “Interval (Event)” field represents the interval of collecting the data of each metric from the elements when a specific event occurs. The “Data Retention (Normal)” field represents the term of monitoring data retention during normal operation. The “Data Retention (Event)” field represents the term of data retention for monitored data during the event.

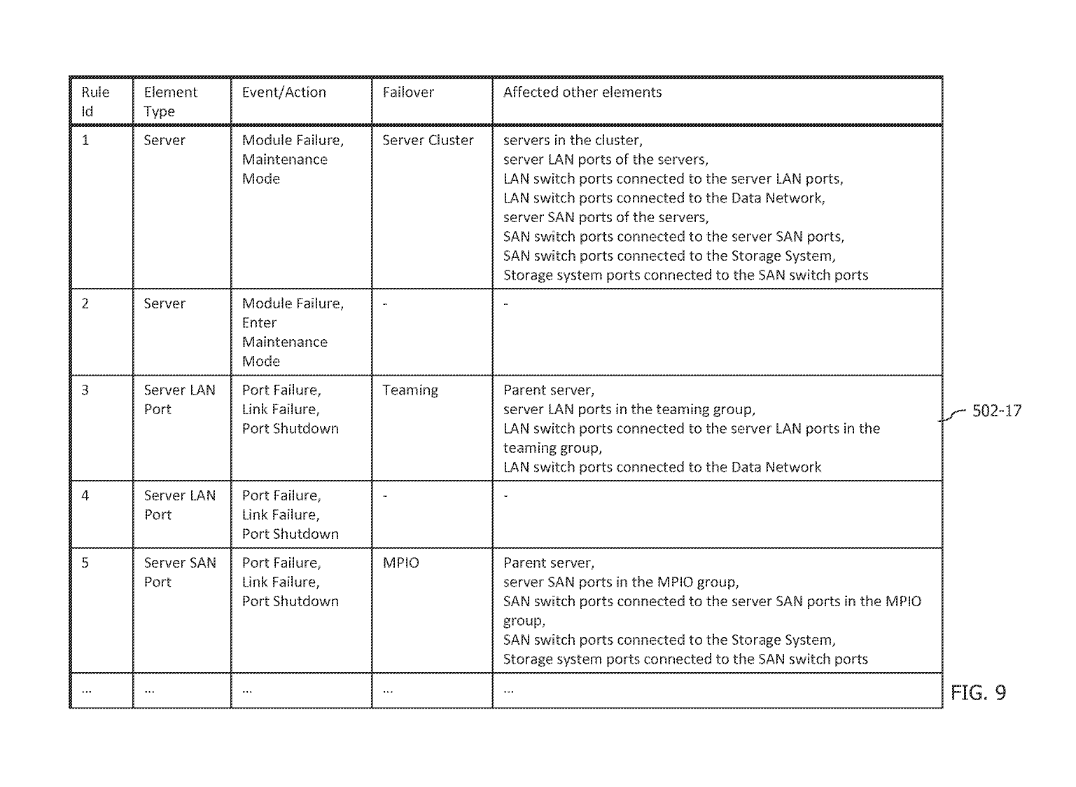

FIG. 9 illustrates an example of the Affected Elements Table 502-17. This table contains the rules to identify the list of elements which has a potential to be affected by a specified event. The “Rule Id” field represents the identifier of the rule. The “Element Type” field represents the type of element. The “Event/Action” field represents the list of events or actions. The “Failover” field represents the method of failover. The “Affected other elements” field represents the elements or ways to identify/calculate the elements which are affected by the events. For example, if “servers in the cluster” are affected elements, then the management server 500 can calculate that the servers in the same cluster as the target server are affected.

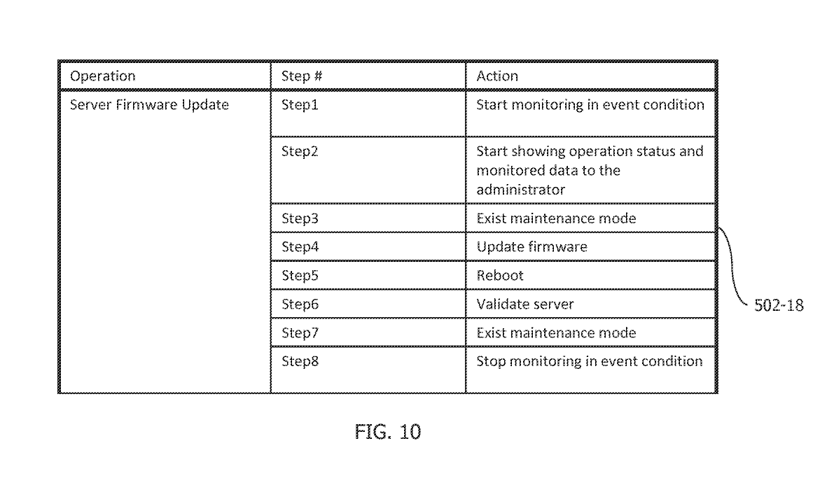

FIG. 10 illustrates an example of the Operation Table 502-18. This table contains the steps for executing management operations. The “Operation” field represents the operation. The “Step #” field represents the step number of the operation. The “Action” field represents the action of each operation step. Management operations can include server firmware update as illustrated in this example as well other operations depending on the desired implementation (e.g. operating system change, system reboot)

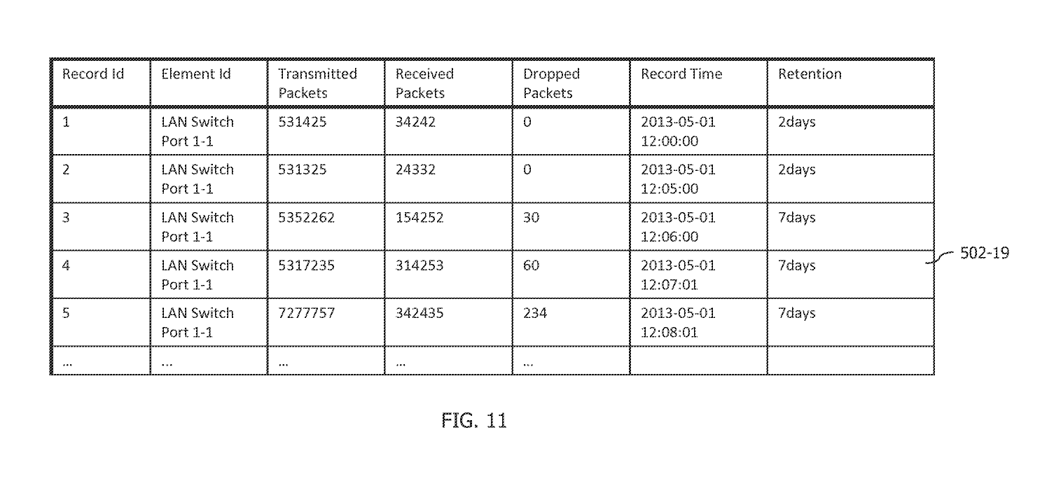

FIG. 11 shows an example of the Performance Data Table (LAN switch port) 502-19. The “Record Id” field represents the identifier of each performance data. The “Element Id” field represents the identifier of the element. The “Transmitted Packets” field represents the packet number transmitted during the monitored interval. The “Received Packets” field represents the packet number received during the monitored interval. The “Dropped Packets” field represents the packet number dropped during the monitored interval. The “Record Time” field represents the time of the data record. The “Retention” field represents the term of retention of the record.

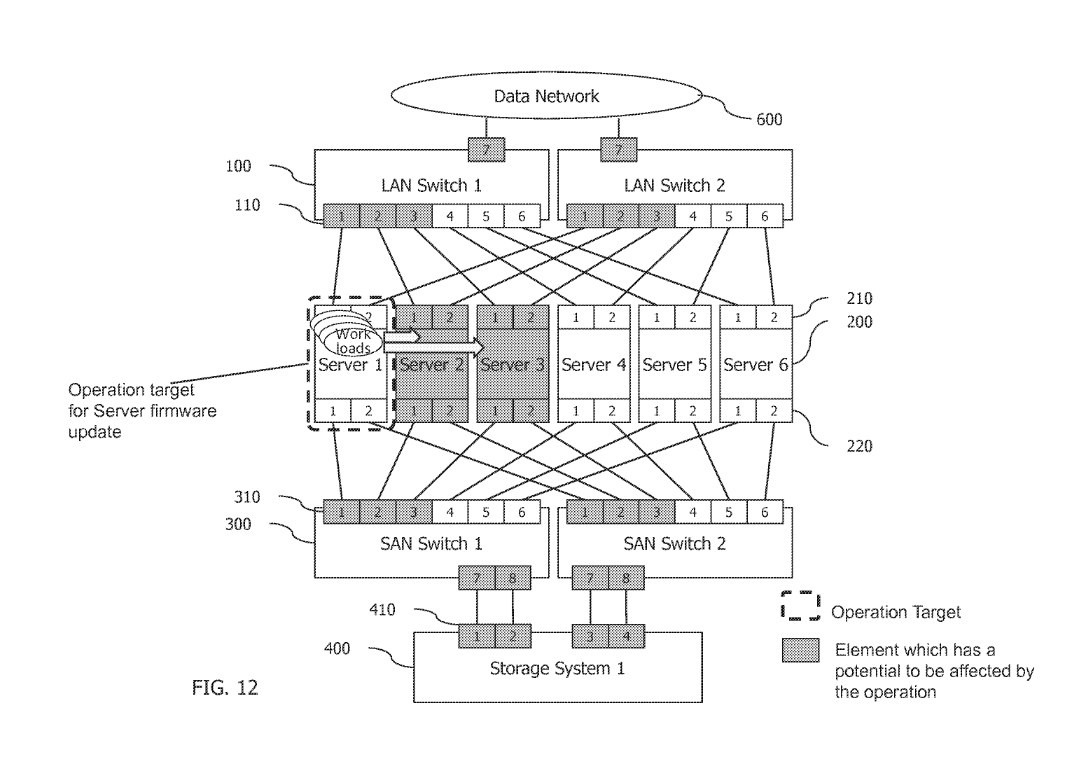

FIG. 12 is an example of the affected elements according to the first example implementation. Specifically, it illustrates the relationship between LAN Switches 100, LAN switch ports 110, servers 200, server LAN ports 210, server SAN ports 220, SAN switches 300, SAN switch ports 310, storage system 400, storage ports 410, and data network 600 for a given event. In the example provided in FIG. 12, “Server 1” undergoes a server firmware update. The elements that have a potential to be affected by the server firmware update operation on “Server 1” include the other servers in the server cluster (i.e. “Server 2”, “Server 3”), LAN switch and SAN switch ports connected to the server cluster, as well as the ports to the data network and storage system that interact with the LAN and SAN switches.

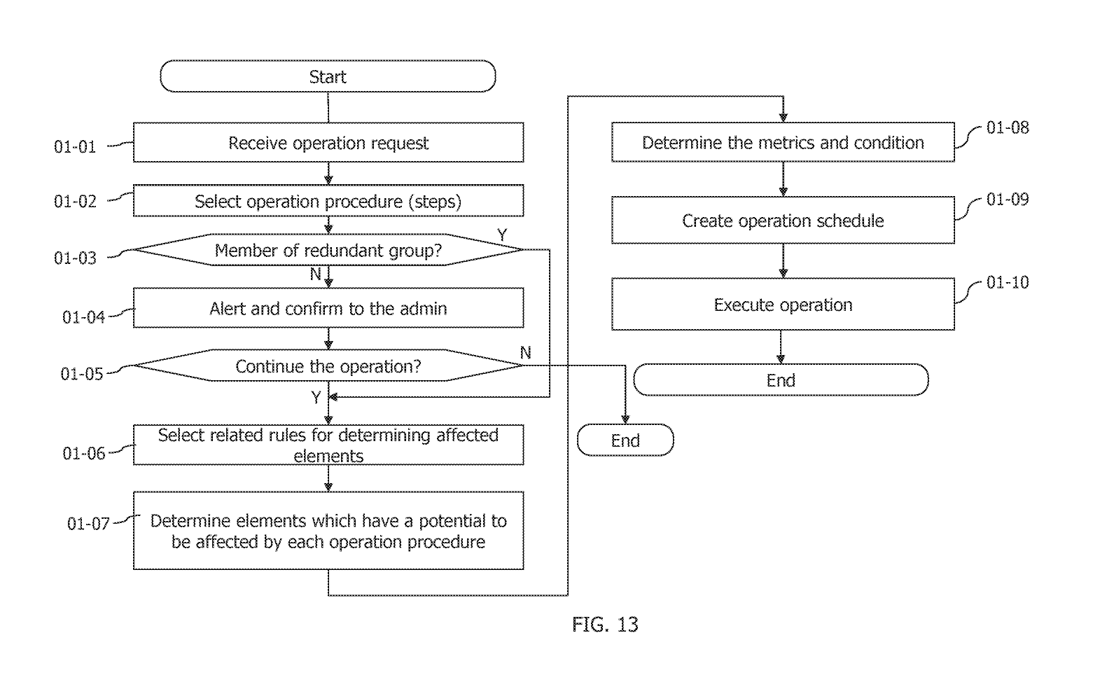

FIG. 13 is a flow diagram illustrating an element management operation flow as executed by the management server 500 according to the first example implementation. This flow diagram starts when the management server 500 receives an operation request such as a server firmware update from system administrator.

At 01-01, the management server 500 receives an operation request such as a server firmware update from the system administrator. In the first example implementation, the operation is a server firmware update and the operation target element is “Server 1” as illustrated in FIG. 12.

At 01-02, the management server 500 selects the operation procedure of the requested operation from Operation Procedure Table 502-18.

At 01-03, the management server 500 calculates if the target element is a member of a redundant group. If so (Y), then the flow diagram proceeds to 01-06. If not (N), then the flow diagram proceeds to 01-04, as the targeted element may not have redundancy to handle the functions of the targeted element when the targeted element is taken down. For example, the management server 500 calculates if the target element is a member of the redundant group such as server cluster, teaming and MPIO based on Server Cluster Table 502-13, Teaming Configuration Table 502-14 or MPIO table 502-15.

The table is selected according to the element type of the target element. For example, if target element type is Server and target element id is “Server 1”, then the management server 500 select a record of Server Cluster Table 502-13 where “Server 1” is included in the “Member Ids” field. If the element is a member of redundant group, the flow diagram proceeds to 01-06; otherwise, the flow diagram proceeds to 01-04.

At 01-04, the management server 500 sends alerts and confirms with the system administrator whether to stop the operation or not. This can be performed via user interfaces provided for the views, such as GUI (Graphical User Interface), CLI (Command Line Interface) and API (Application Programmable Interface).

If the administrator allows the operation to continue (Y), the program proceeds to 01-06; otherwise, the flow diagram ends at 01-05.

At 01-06, the management server 500 determines the rules for each operation step from the Affected Elements Table 502-17, where the “Element Type” field has the element type of the target element, the “Event/Action” field has the operation step, and the “Failover” field has the redundant way which was determined at 01-03. For example, the rule which has rule Id “1” is selected since the target element type is “Server”, the action of step 1 of the “Server Firmware Update” operation procedure (FIG. 10) is “Enter maintenance mode”, and the “Server 1” is a member of “Server Cluster 1”.

At 01-07, the management server 500 determines the elements which have a potential to be affected by each operation step using rules selected at 01-06. For example, the Rule Id “1” has a list of rules identifying other affected elements, such as “servers in the cluster”, “server LAN ports of the servers”, “LAN switch ports connected to the server LAN ports”, “LAN switch ports connected to the Data Network”, “server SAN ports of the servers”, “SAN switch ports connected to the server SAN ports”, “SAN switch ports connected to the Storage System” and “Storage system ports connected to the SAN switch ports”. In the example of FIG. 12, “Server 2” and “Server 3” are selected by the “servers in the cluster” since these servers are members of same server cluster in Server Cluster Table 502-13. Similarly, all elements which have a potential to be affected by each operation step are identified, as shown in FIG. 12.

At 01-08, the management server 500 determines the metrics and condition according to the elements determined at 01-07 by using Monitoring Metrics Table 502-15.

At 01-09, the management server 500 creates an operation schedule which includes monitoring for the selected elements and metrics.

At 01-10, the management server 500 executes the operation according to the operation schedule.

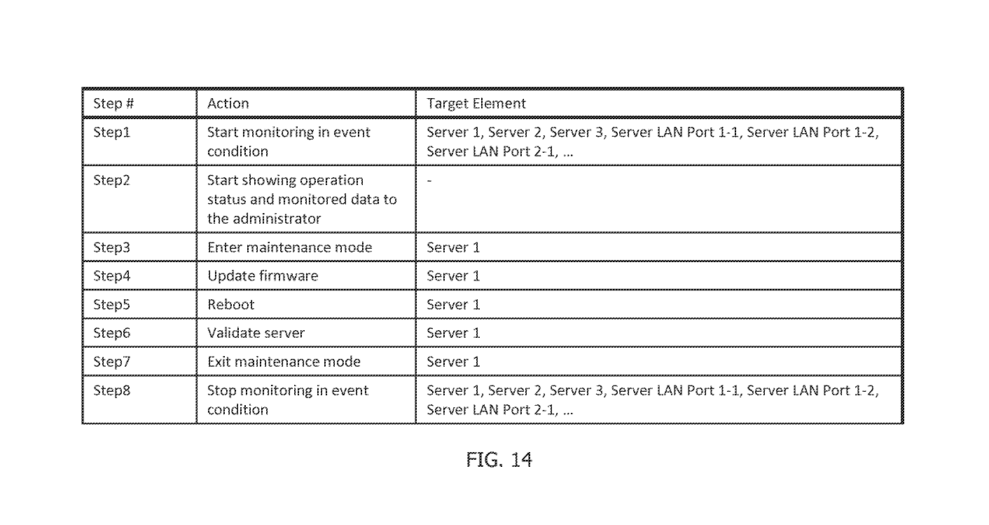

FIG. 14 illustrates an example of the created operation schedule. The created operation schedule associates each step of the operation with an action and a target element of the system. The steps illustrated in the example of FIG. 14 are for updating the firmware in “Server 1”, which may necessitate downtime for “Server 1”, thereby affecting other elements related to “Server 1”. The example implementation calculates the steps for updating the firmware and the affected elements for each step in the process.

### Second Example Implementation

### Performance Monitoring at Element Failure

The second example implementation illustrates changing monitoring conditions at an element failure of the computer system. The computer system configuration and tables illustrates in FIGS. 1-11 are the same for the second example implementation.

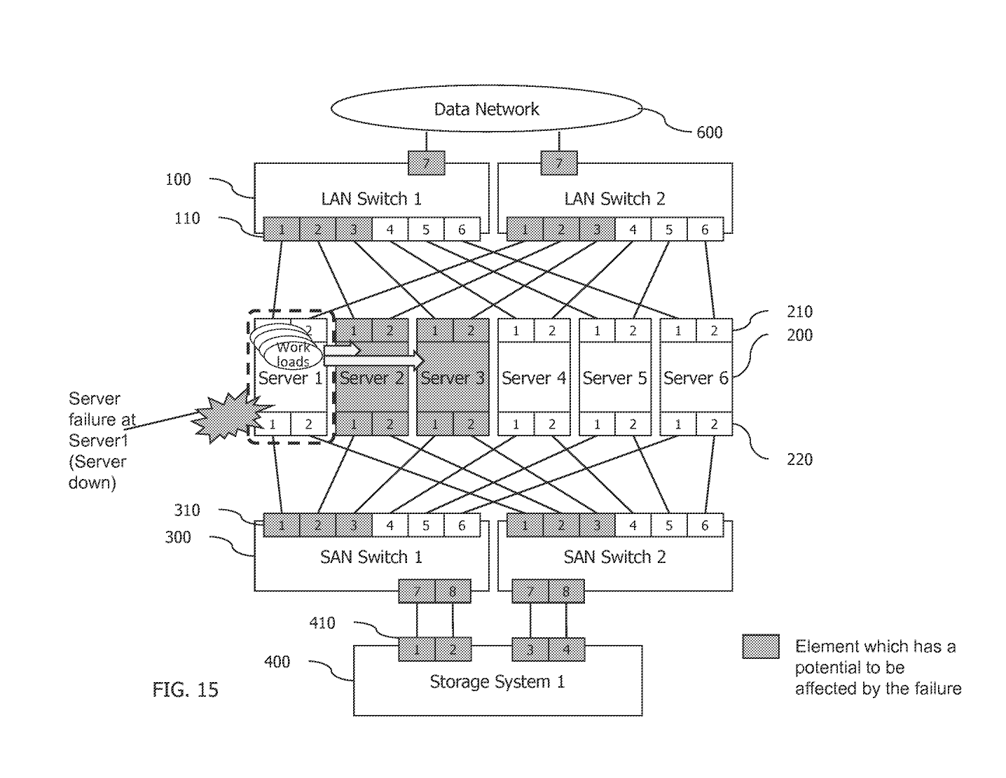

FIG. 15 illustrates an example of the affected elements according to the second example implementation. The second embodiment assumes the server failure (server down) happened at “Server 1”; and workloads on the “Server 1” migrate to other member servers in the server cluster group by the server cluster feature. Specifically, FIG. 15 illustrates the relationship between LAN Switches 100, LAN switch ports 110, servers 200, server LAN ports 210, server SAN ports 220, SAN switches 300, SAN switch ports 310, storage system 400, storage ports 410, and data network 600 according to the second example implementation. In the example illustrated in FIG. 15, a server failure occurs at “Server 1”. The elements that have a potential to be affected by the server failure of “Server 1” include the other servers in the server cluster (i.e. “Server 2”, “Server 3”), LAN switch and SAN switch ports connected to the server cluster, as well as the ports to the data network and storage system that interact with the LAN and SAN switches.

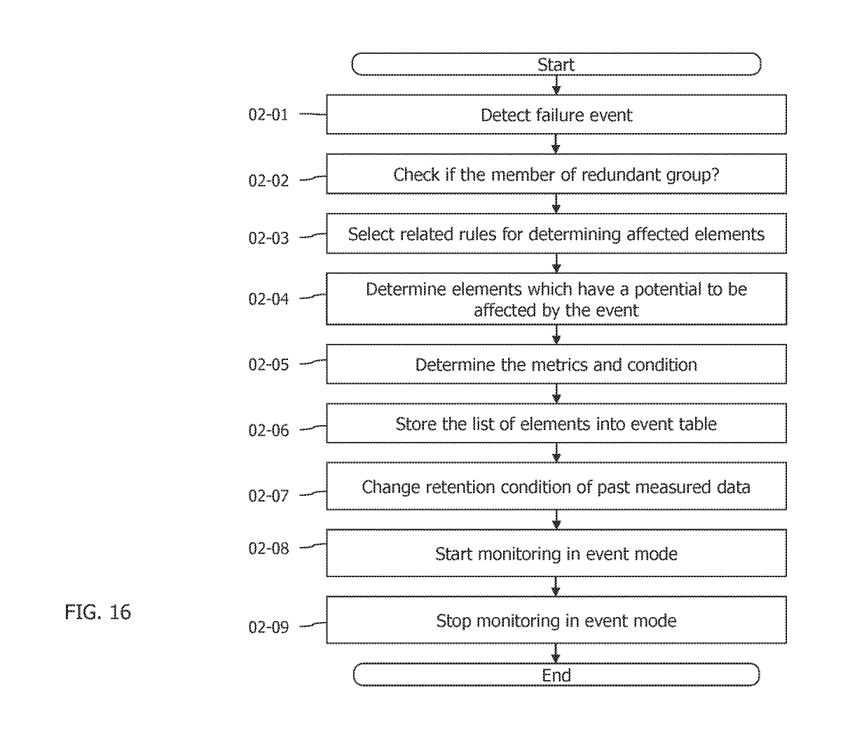

FIG. 16 is a flow diagram illustrating a monitoring condition change in an element failure as executed by the management server 500 according to the second example implementation.

At 02-01, the management server 500 detects an element failure event such as server failure. This can be detected by any monitoring technique known to one of ordinary skill in the art.

At 02-02, the management server 500 evaluates if the target element is a member of the redundant group such as server cluster, teaming and MPIO based on the Server Cluster Table 502-13, Teaming Configuration Table 502-14 or MPIO table 502-15. The table is selected according to the element type of the target element. For example, if the target element type is Server and target element id is “Server 1”, then the management server 500 selects a record of Server Cluster Table 502-13 where “Server 1” is included in the “Member Ids” field.

At 02-03, the management server 500 selects the rules for an event from the Affected Elements Table 502-17 where the “Element Type” field has the element type of the target element, the “Event/Action” field has the event, and the “Failover” field has a redundant way as determined at 02-02. For example, the rule which has rule Id “1” is selected since target element type is “Server”, the detected event is “module failure”, and the “Server 1” is member of “Server Cluster 1”.

At 02-04, the management server 500 determines the elements that have a potential to be affected by the event using selected rules at 02-03. For example, the Rule Id “1” has the list of rules identifying other elements affected, such as “servers in the cluster”, “server LAN ports of the servers”, “LAN switch ports connected to the server LAN ports”, “LAN switch ports connected to the Data Network”, “server SAN ports of the servers”, “SAN switch ports connected to the server SAN ports”, “SAN switch ports connected to the Storage System”, and “Storage system ports connected to the SAN switch ports”. In the example of FIG. 15, “Server 2” and “Server 3” are selected by the “servers in the cluster” since these servers are member of the same server cluster from Server Cluster Table 502-13. In a similar way, all elements that have a potential to be affected by each operation step are identified. FIG. 15 shows identified elements in the second embodiment.

At 02-05, the management server 500 determines the metrics and condition for conducting the monitoring, according to the elements as determined at 02-04 using the Monitoring Metrics Table 502-15.

At 02-06, the management server 500 stores event information into the Event Table 502-20 which includes the determined elements information.

At 02-07, the management server 500 changes the retention condition of past measured records of the Performance Data Table 502-19. The records are selected by the determined elements from the flow at 02-04, determined metrics from the flow at 02-05, and the “Record Time” within the pre-defined term from the event time.

At 02-08, the management server 500 changes the monitoring condition to the determined elements and metrics in event condition.

At 02-09, the management server 500 changes the monitoring condition to the determined elements and metrics in the normal condition.

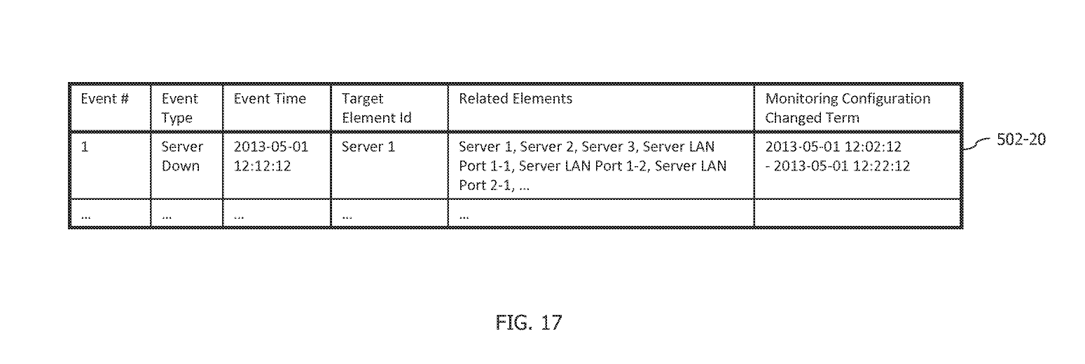

FIG. 17 is an example of the Event Table 502-20. The “Event #” field represents the identifier of each event. The “Event Type” field represents the type of event, such as “Server Down”. The “Event Time” field represents the timestamp of the event. The “Target Element Id” field represents the element ID of the main related element of the event. The “Related Elements” field represents the list of related elements as estimated from the flow at 02-04. The “Monitoring Configuration Changed Term” field represents the term during which the monitoring condition changed.

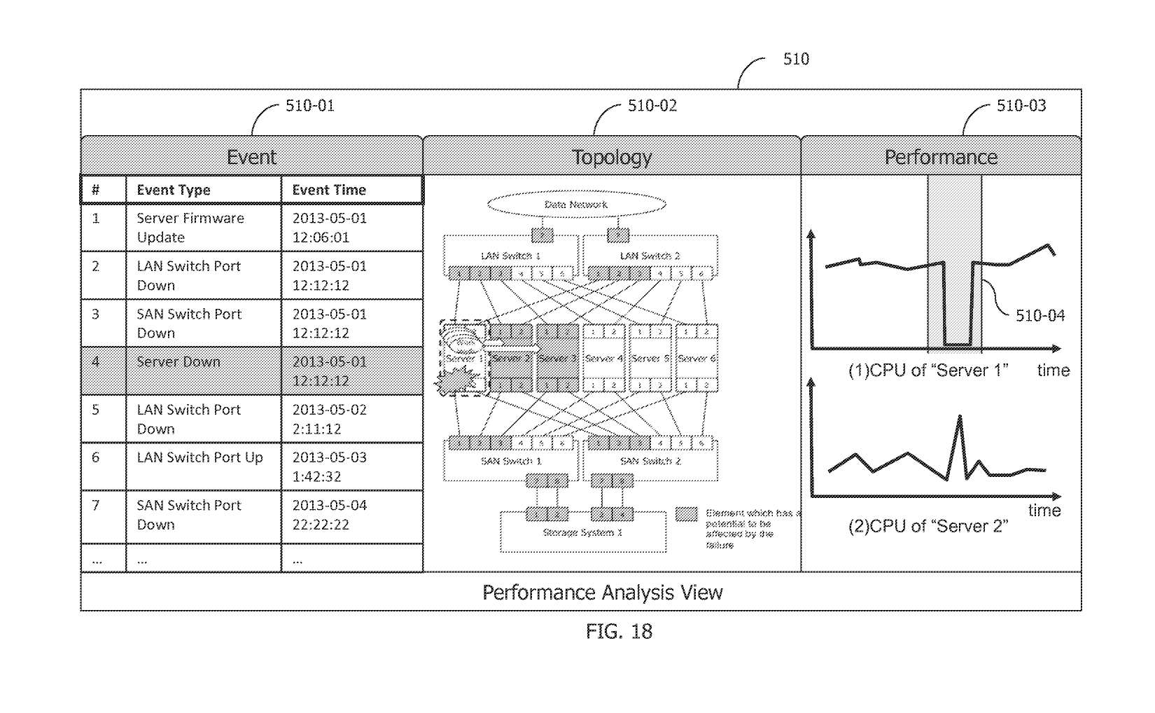

FIG. 18 is an example of the performance analysis GUI 510. Performance analysis GUI 510 can be provided by the Performance View GUI Management 502-04, which can provide various views to the administrator. In the example of FIG. 18, the performance analysis GUI 510 is in the form of a view with three panes. The Event pane 510-01 shows an event list using the data in the Event Table 502-19. The Topology pane 510-02 shows a computer system topology image, which includes the target element of the event related elements of the data in the Event Table 502-19, and redundancy information such as server cluster. In FIG. 18, the Topology pane 510-02 shows the target element of the event and the related elements are emphasized. The Performance pane 510-03 shows graphs of performance data using the Performance Data Table 502-19 and can include a highlight of a time period for an event (e.g., Server Down) as shown at 510-04.

Each pane can be selected, and the other panes can be shown with related data in the selected pane. For example, if the system administrator selects one of the events on the Event pane 510-01, then the management server 500 can select the target and related elements from Event Table 502-20 and show them in the Topology pane 510-02. Thereafter, the management server 500 can show performance data graphs of the target and related elements in the Performance pane 510-03.

If the system administrator selects the graphs of the element and the time range of performance data on the Performance pane 510-03, then the management server 500 searches event records in Event Table 502-19 which have the selected element in the “Related Elements” field where the time range is overlapping with the “Monitoring Configuration Changed Term” field. Then, the management server 500 shows the event and the topology related to the selected performance graph and time range. This allows the system administrator to analyze the performance data related to the event easily.

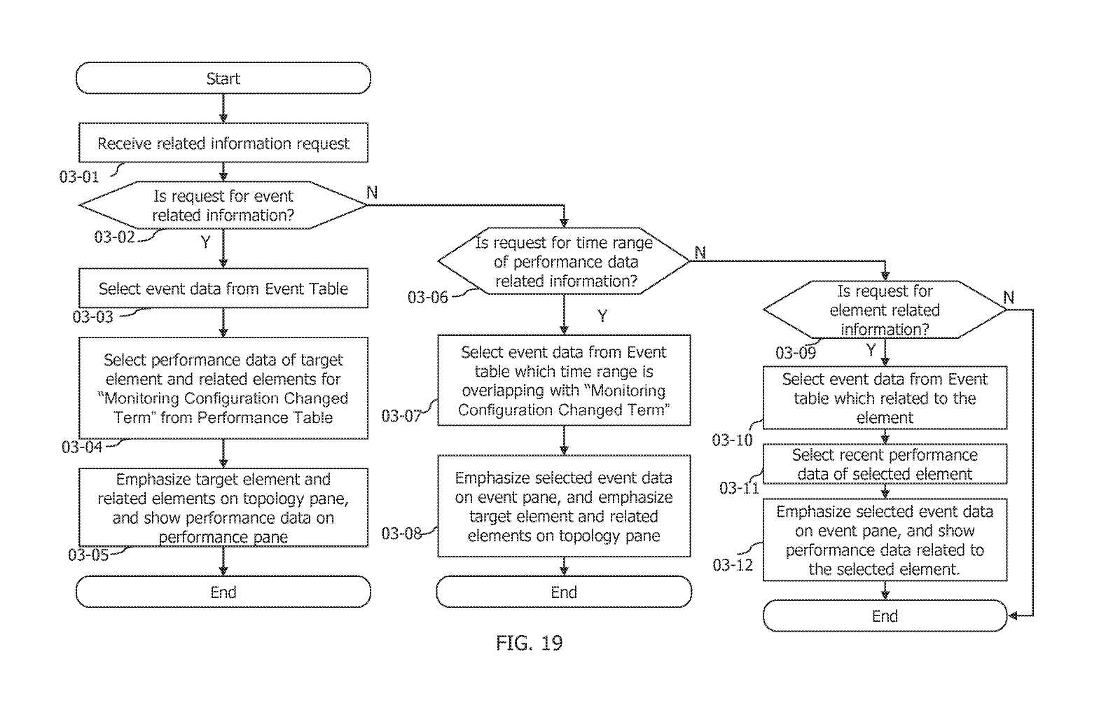

FIG. 19 illustrates a flow diagram illustrating a performance analysis operation using the performance analysis GUI 510. This flow diagram can be performed by the management server 500 by executing Performance View GUI Management 502-04.

At 03-01, the management server 500 receives a related information request. The request is originated by the system administrator's action on the performance analysis GUI 510. Examples of the action are “selecting event on the event pane”, “selecting the element on the topology pane”, and “selecting time range on the performance pane”.

At 03-02, if the request is for the event related information caused by selecting an event on the Event pane 510-01 (Y), then the flow proceeds to 03-03; otherwise (N), it proceeds to 03-06.

At 03-03, the management server 500 selects event data of the selected event from Event Table 502-20.

At 03-04, the management server 500 selects performance data of the target and related elements of the event data from Performance Data Table 502-19 for the term of the “Monitoring Configuration Changed Term” field.

At 03-05, the management server 500 shows emphasized target and related elements on the Topology pane 510-02. Then, the management server 500 shows the performance data on the Performance pane 510-03.

At 03-06, if the request is for related information of the time range of the performance data of the element caused by selecting the time range on the performance graph of the element on the Performance pane 510-03 (Y), then the flow proceeds to 03-07; otherwise (N), the flow proceeds to 03-09.

At 03-07, the management server 500 selects one or more event data entries from Event table 502-20 where the “Monitoring Configuration Changed Term” field overlaps with the requested time range and element Id is in the “Target Element Id” or “Related Elements” fields.

At 03-08, the management server 500 shows the emphasized one or more selected event data entries on the Event pane 510-01, and related elements on the Topology pane 510-02.

At 03-09, if the request is for related information of element caused by selecting an element on the Topology pane 510-02 (Y), then the program proceeds to 03-10; otherwise (N), it proceeds to end.

At 03-10, the management server 500 selects one or more event data entries from Event table 502-20 where the selected element id is in the “Target Element Id” or “Related Elements” fields.

At 03-11, the management server 500 selects the recent performance data of the target element from Performance Data Table 502-19.

At 03-12, the management server 500 shows the selected event data on Event pane 510-01 and shows performance data on the Performance pane 510-03.

### Third Example Implementation

### Performance Monitoring of Multiple Computer Systems

The third example implementation illustrates changing monitoring conditions upon element failure across multiple computer systems.

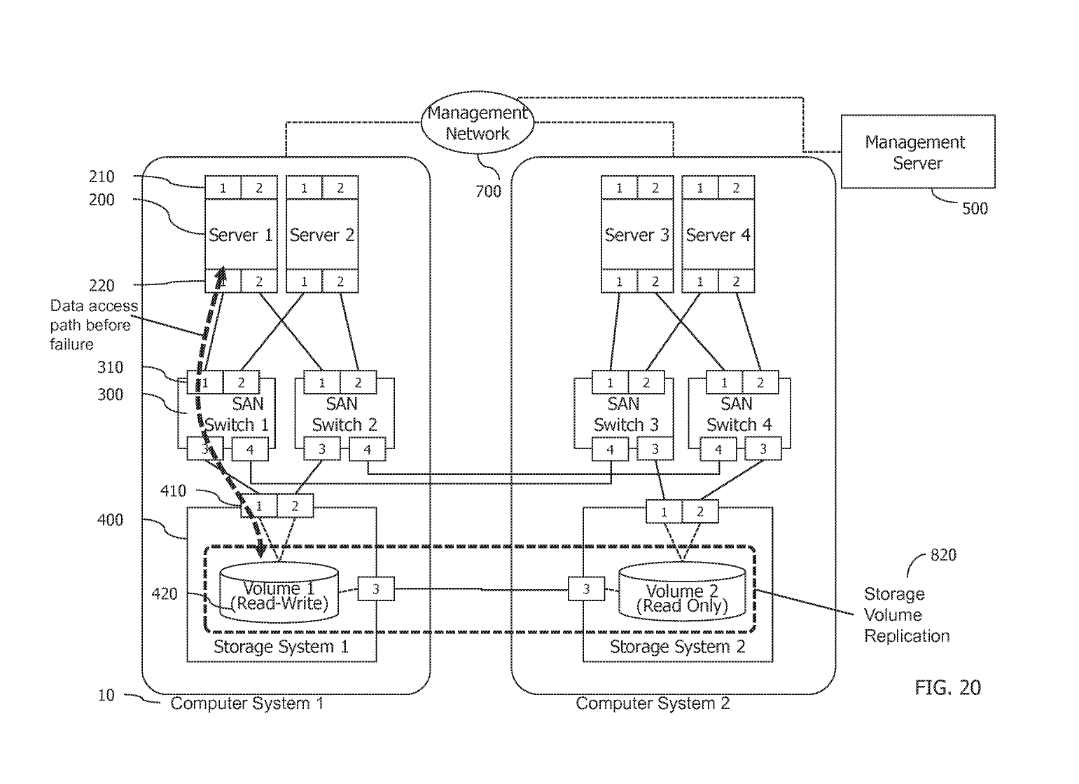

FIG. 20 illustrates an example of a system configuration of the third example implementation. The system configuration includes multiple Computer Systems 10, Management Network 700, Management Server 500, and Storage Volume Replication 820. Each Computer System 10 includes a server 200, server LAN port 210, server SAN (Storage Area Network) port 220, SAN switch 300, SAN switch port 310, storage system 400, storage port 410, and storage volume 420.

In this third example implementation, each computer system has two SAN switches 300 (e.g., “SAN Switch 1”, “SAN Switch 2”), two servers 200 (e.g., “Server 1”, “Server 2”), and one storage system for each computer systems 400 (e.g., “Storage System 1” for “Computer System 1”, “Storage System 2” for “Computer System 2”). Each server 200 has two LAN switch ports 210 and two SAN switch ports 220. Each server 200 is also connected to two SAN switches via SAN switch ports 220 to improve redundancy. The storage volumes 420 (e.g., “Volume 1” and “Volume 2”) on both storage systems are configured as volume replication to improve volume redundancy. The storage ports ‘3’ of “Storage System 1” and “Storage System 2” are connected each other and configured to transmit replication data between storage systems. “SAN Switch 1” is connected to “SAN Switch 3”, and “SAN Switch 2” is connected to “SAN Switch 4”. This connectivity allows Server 200 to access storage volume 420 of storage system 400 across different computer systems 10.

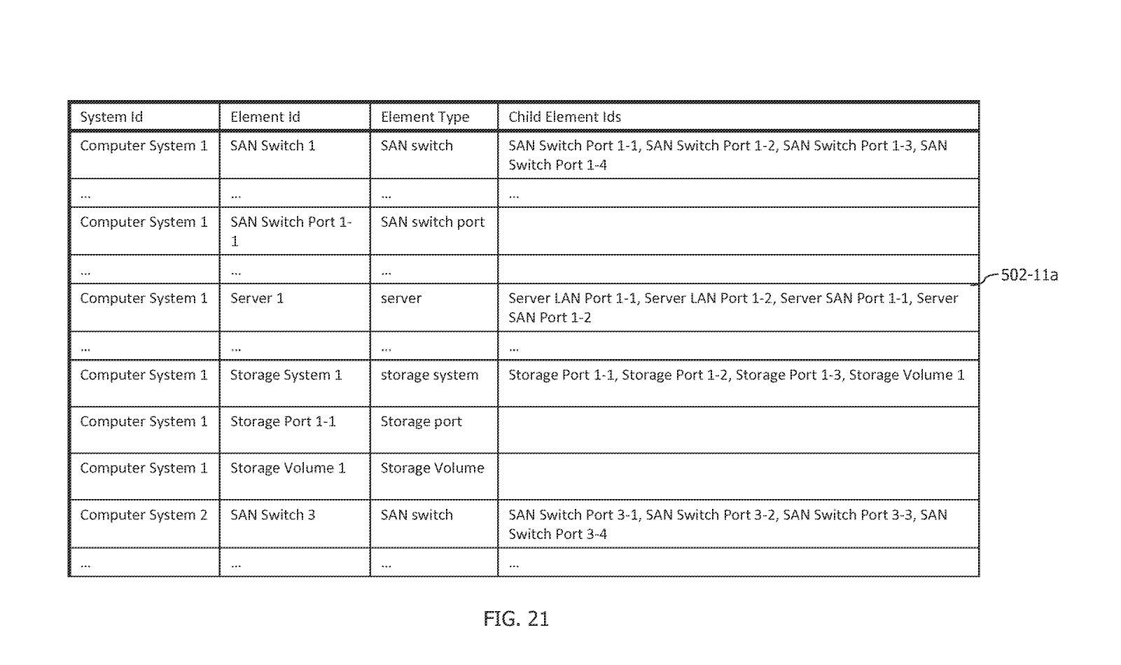

FIG. 21 illustrates an example of the System Element Table 502-11a of the third example implementation. In addition to the System Element Table 502-11 (FIG. 3) in the first example implementation, the “System Id” field is added, which represents the identifiers of the computer systems 10.

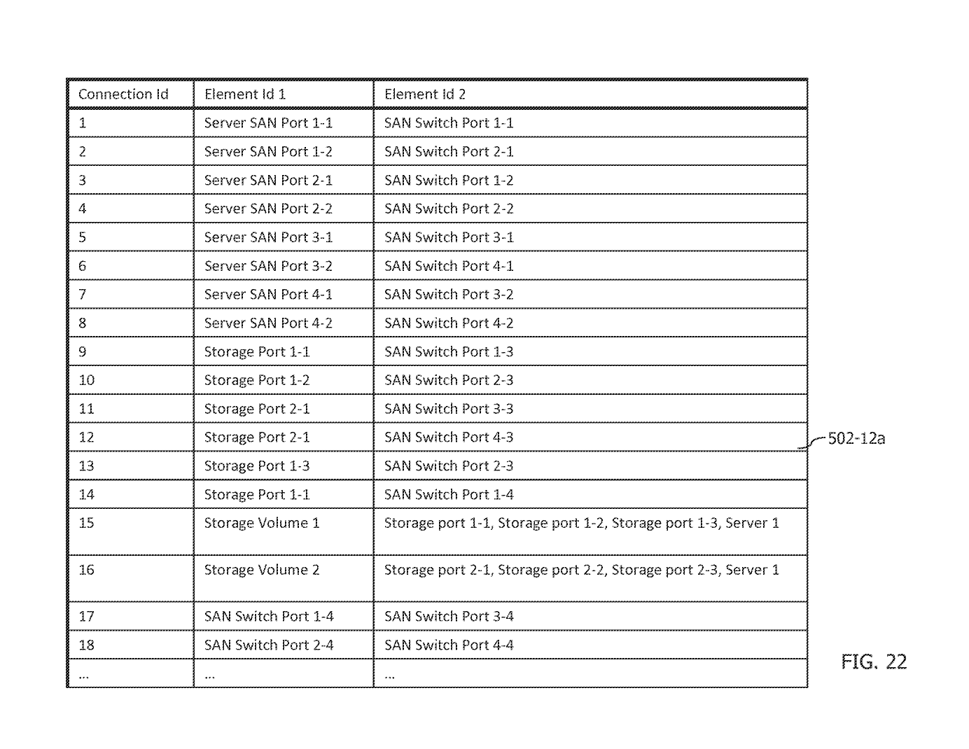

FIG. 22 illustrates an example of the Connectivity Table 502-12a of the third example implementation. This table represents the connectivity information between elements of the computer system's physical connectivity and logical connectivity. For example, FIG. 22 shows “Storage Volume 1” is connected to storage port 1-1, 1-2, 1-3 and “Server 1” (“Connection Id 15” in FIG. 22). These storage volume connections are logical connections that can be implemented by any technique known to one of ordinary skill in the art (e.g., port mapping, Logical Unit Number masking).

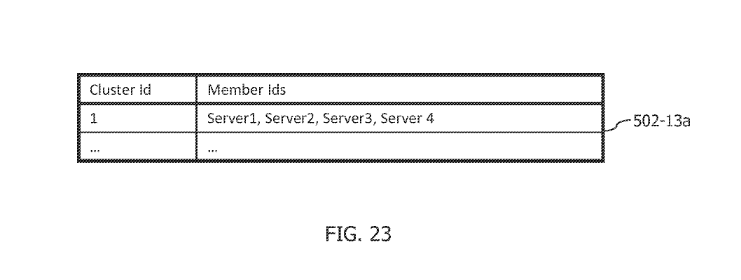

FIG. 23 illustrates an example of the Server Cluster Table 502-13a of the third example implementation. The table schema of Server Cluster Table 502-13a is the same as the Server Cluster Table 502-13 (FIG. 5) in the first example implementation. In a similar manner, the Teaming Configuration Table 502-14 (FIG. 6), MPIO Configuration Table 502-15 (FIG. 7) and Monitoring Metrics Table 502-16 (FIG. 8) from the first example implementation can also be utilized in the third example implementation.

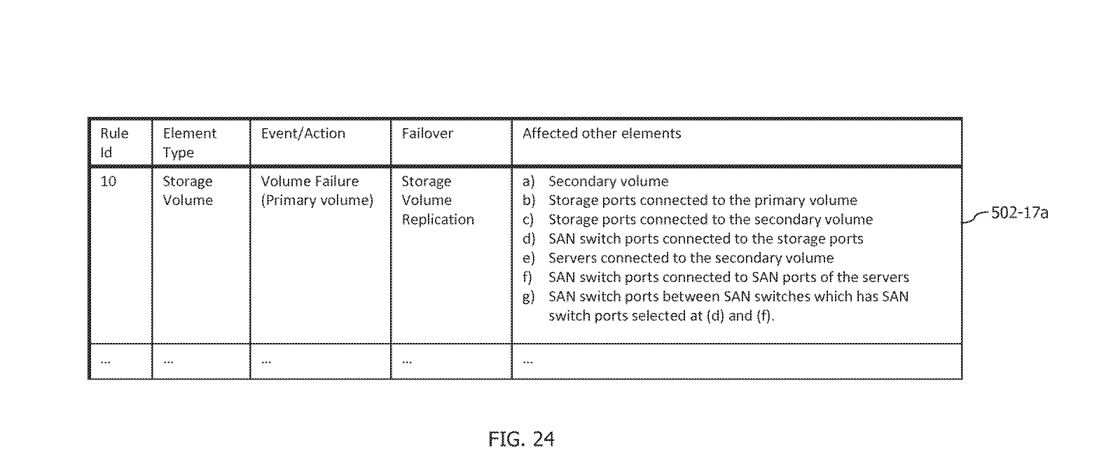

FIG. 24 is an example of the Affected Elements Table 502-17a of the third example implementation. The table schema is the same as the Affected Element Table 502-17 (FIG. 9) in the first example implementation. In the third example implementation, an example of the rule for storage volume failure is added to the Affected Elements Table 502-17a.

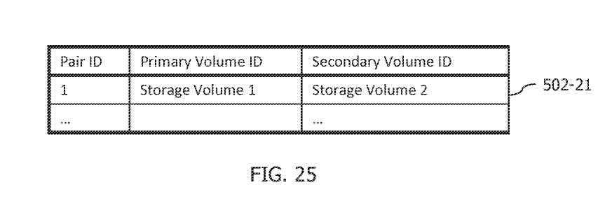

FIG. 25 is an example of the Storage Volume Replication Table 502-21. This table represents the configuration of volume replication between the storage systems. The volume replication is an example of storage volume duplication over the storage area network. The “Pair Id” field represents the identifier of each storage volume replication. The “Primary Volume Id” field represents the identifier of the primary volume. The “Secondary Volume Id” field represents the identifier of the secondary volume.

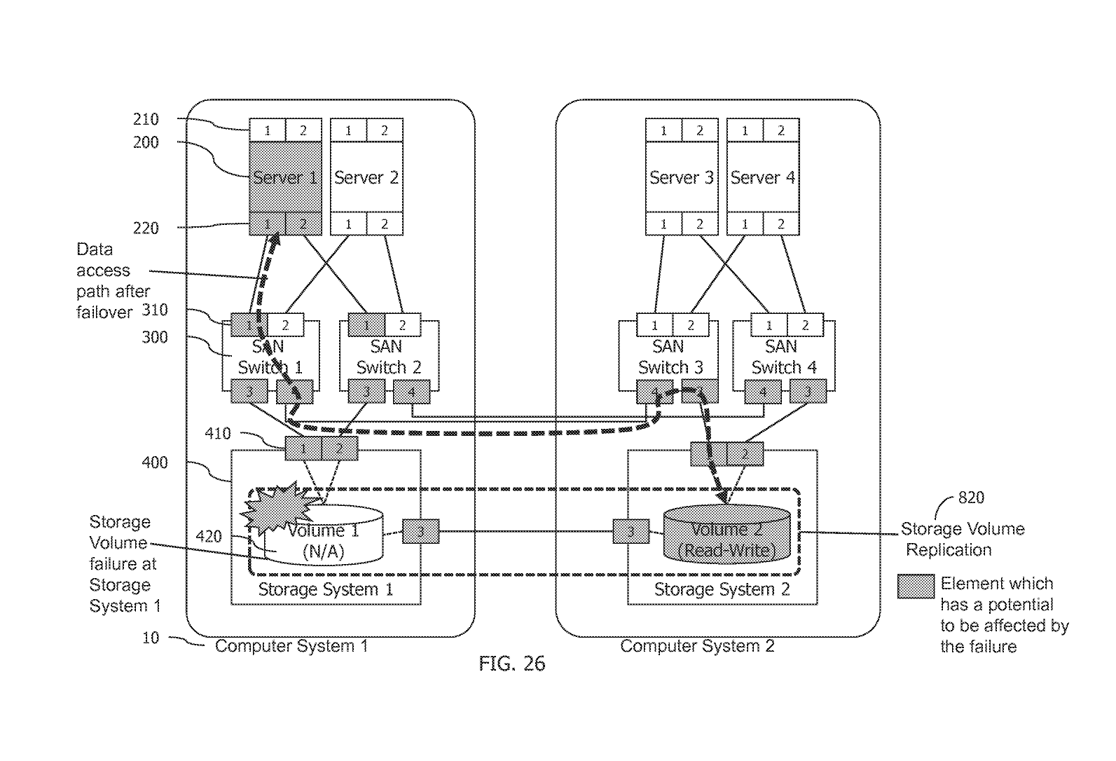

FIG. 26 illustrates the affected elements according to the third example implementation. In this example for the third example implementation, primary volume (“Volume 1”) failure occurred at “Storage System 1”, wherein “Storage System 2” detects the failure, and the secondary volume (“Volume 2”) of “Storage System 2” becomes “read-write” mode. Thereafter, “Server 1” starts accessing data on the “Volume 2” instead of “Volume 1”.

The flowchart of the monitoring the condition change during an element failure can be the same as FIG. 16 in the second example implementation. The difference from the second example implementation is that at 02-02, the management server 500 can also evaluate if the target element is a member of the redundant group by using Storage Volume Replication Table 502-21 in addition to Server Cluster Table 502-13, Teaming Configuration Table 502-14, and MPIO table 502-15.

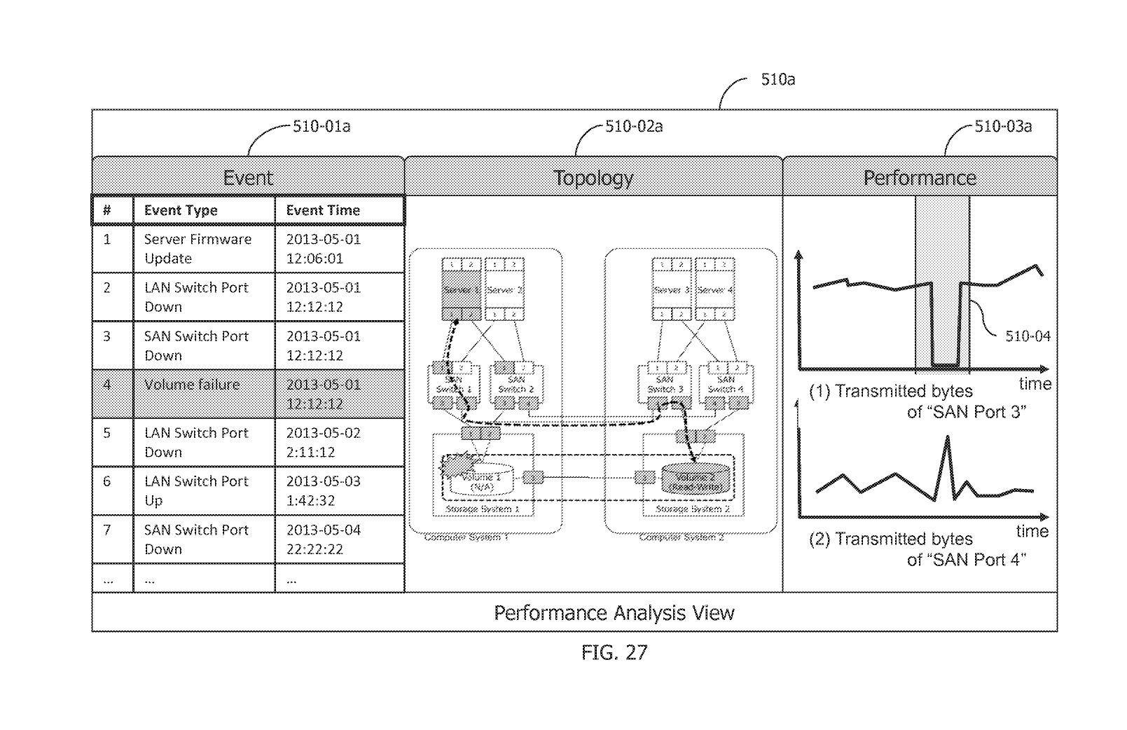

FIG. 27 illustrates an example of the Performance Analysis GUI 510a in the third example implementation. As described in FIGS. 18 and 19, performance analysis GUI 510a can also be provided by the Performance View GUI Management 502-04 and also includes Event pane 510-01a, Topology pane 510-02a, and Performance pane 510-03a. The GUI structure is same as the performance analysis GUI 510 (FIG. 18) in the second example implementation. In the third example implementation, Topology pane 510-02a shows the topology of multiple computer systems, which can include the target element of the event, related elements the data, and redundancy information such as storage volume replication. Performance pane 510-03a shows graphs for elements from any of the computer systems. Event pane 510-01a shows events which can also be sorted by computer system as further explained below. This GUI thereby allows the system administrator to analyze the performance data related to the event affecting multiple computer systems.

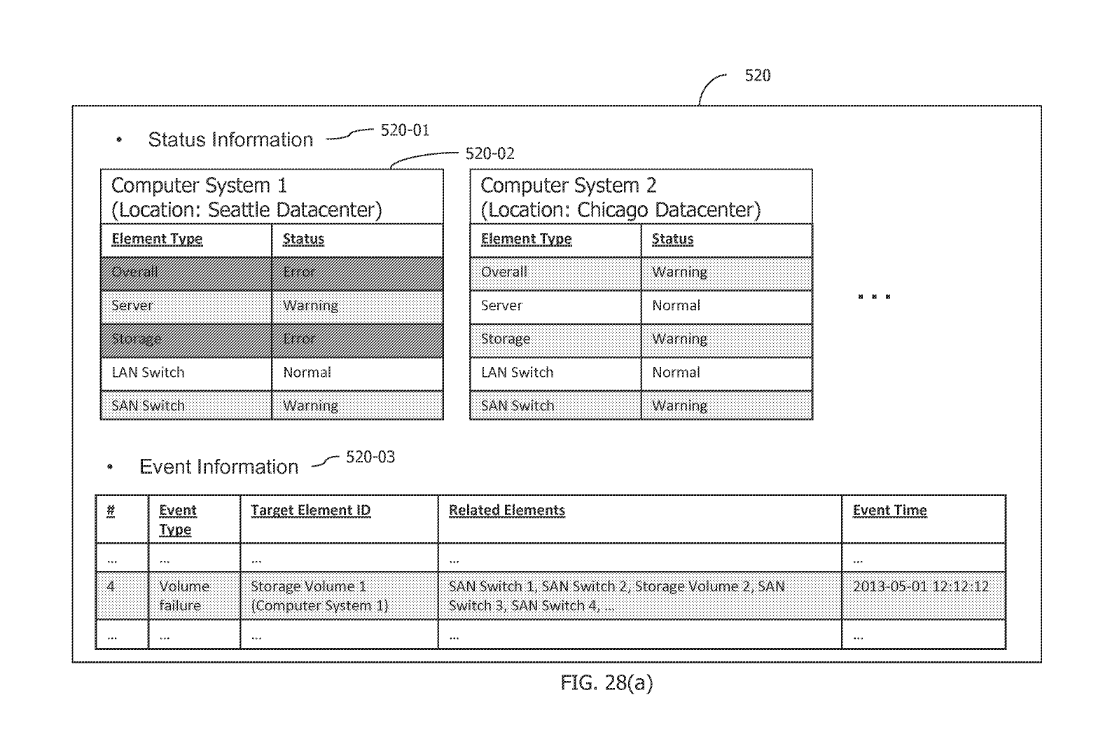

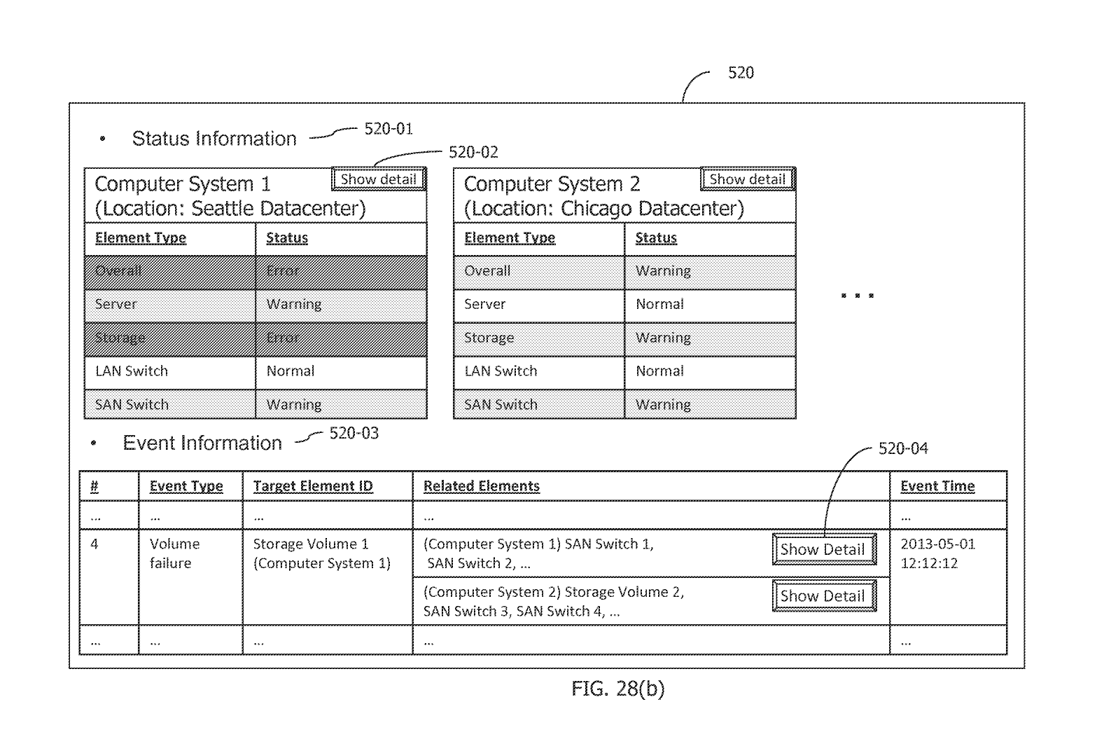

FIGS. 28(a) and 28(b) illustrate an example of the Multiple Computer System Monitoring GUI 520 in the third example implementation. Multiple Computer System Monitoring GUI 520 can be provided by the Performance View GUI Management 502-04 as a separate view, or a selectable view within Performance Analysis GUI 510a.

As shown in FIG. 28(a), the Multiple Computer System Monitoring GUI 520 can include Status information 520-01, which can include information (e.g., element type such as overall system, server, storage, LAN Switch, SAN Switch, etc.) and health statuses of elements (e.g., error, warning, normal, etc.) across one or more computer systems as shown at 520-02. Event information 520-03 can include information regarding events that have occurred across one or more computer systems and can be sorted by computer system as shown in the Target Element ID.

As shown in FIG. 28(b), click-throughs can be provided to show more detail of specific aspects of the Multiple Computer System Monitoring GUI 520, wherein additional views can be provided that display related information in more detail. The additional views can provide further detailed information about the elements or the computer systems, depending on the desired implementation.

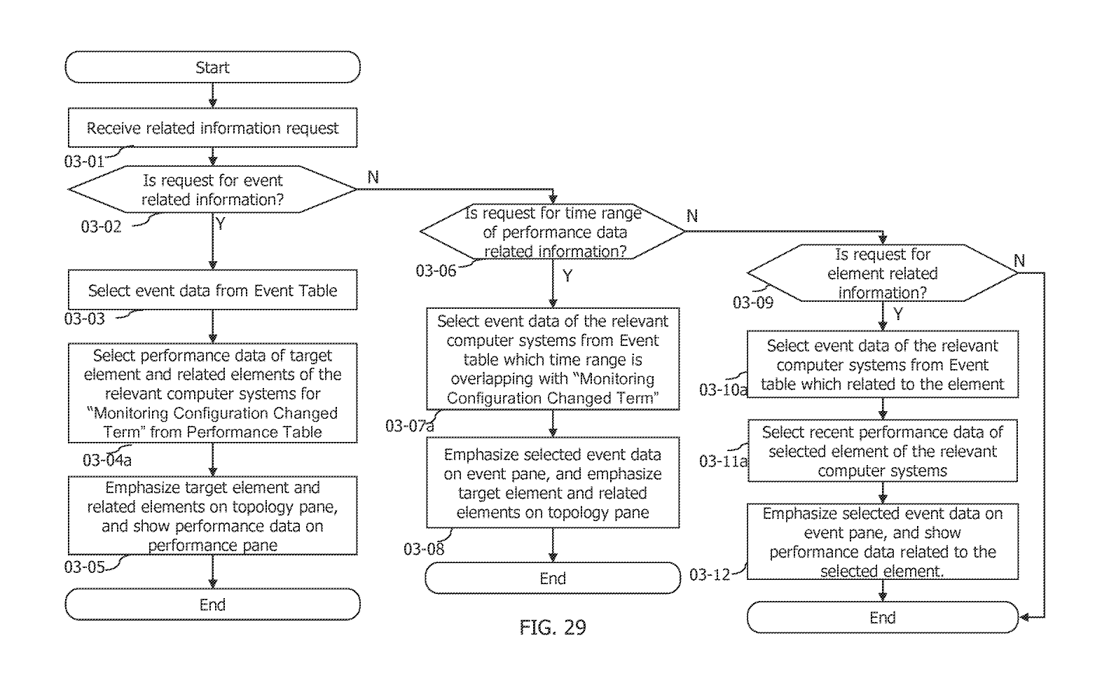

FIG. 29 illustrates a flow diagram illustrating a performance analysis operation using the Performance Analysis GUI 510a. This flow diagram is similar to FIG. 19 and can be performed by the management server 500 by executing Performance View GUI Management 502-04. The difference in a multi-computer system situation is that information indicating the relevant computer system of the target and related elements should also be provided to the administrator. The flow at 03-04a, 03-07a, 03-10a, and 03-11a are modified from FIG. 19 to provide information of the relevant computer systems for the view. For example, at 03-04a, the performance data of the target element and related elements of the relevant computer systems are selected. At 03-07a, event data of the relevant computer systems is provided. At 03-10a, event data of the relevant computer systems that are related to the requested element are selected. At 03-11a, recent performance data of the selected element of the relevant computer systems is selected. Further, as illustrated in FIGS. 28(a) and 28(b), if status or event information is requested, then the data can be sorted by the relevant computer system, or the relevant computer system can be displayed for the target and related elements.

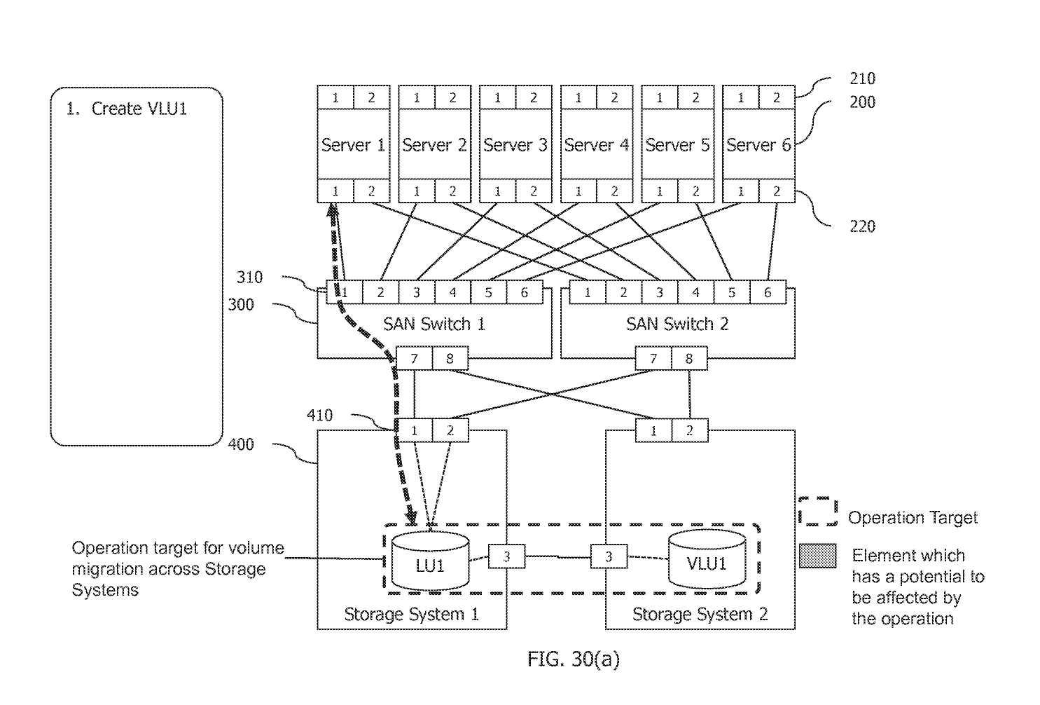

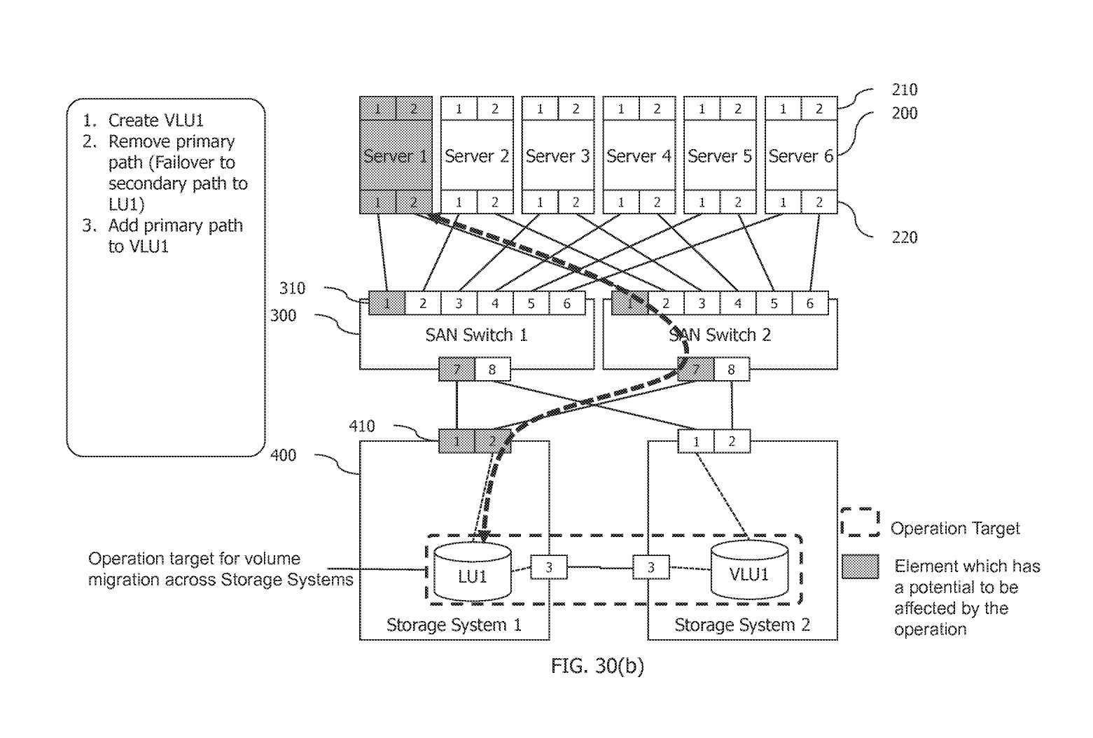

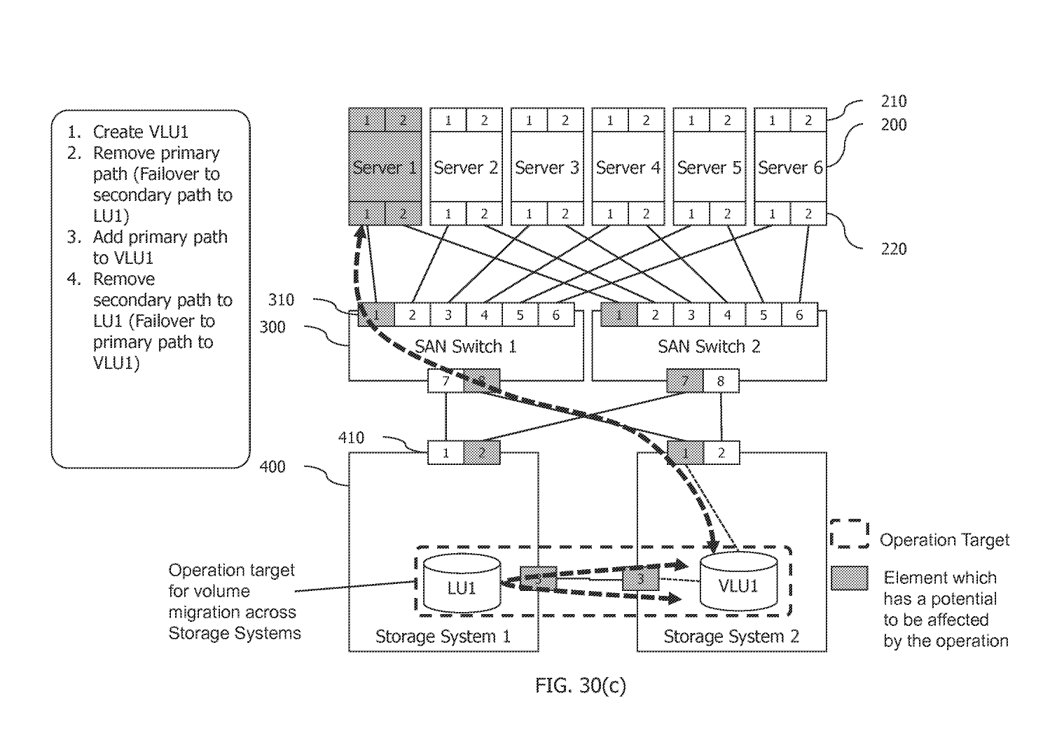

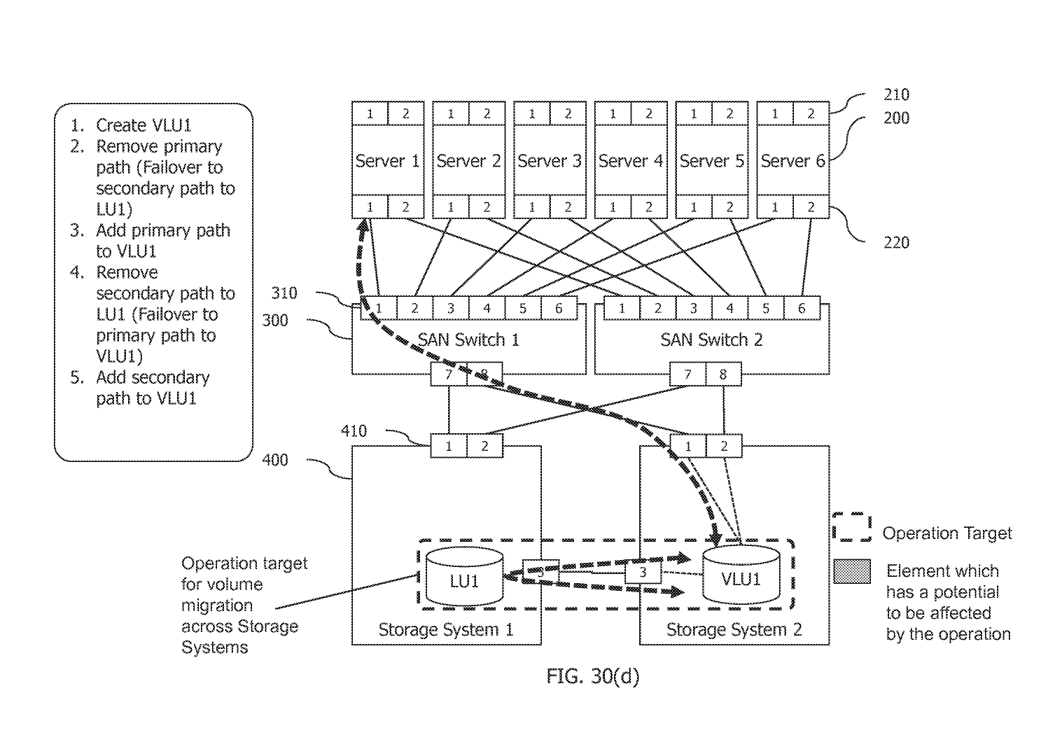

FIGS. 30(a) to 30(d) illustrate an example of affected elements during a volume migration across storage systems, according to the third example implementation. The volume migration can be conducted by any technique known to one of ordinary skill in the art, and can also be implemented in conjunction with a created operation schedule to relate the volume migration procedure at each step to the affected elements.

In FIG. 30(a), a virtual logical unit VLU1 is created in “Storage System 2” as part of the volume migration, wherein the primary path runs from the first port of “Server 1” to LU1 via “SAN Switch 1”. In FIG. 30(b), the primary path to the primary volume LU1 is removed and changed over to the secondary path as illustrated from “Server 1” to LU1 via “SAN Switch 2”, and the corresponding affected elements are highlighted. In FIG. 30(c), the primary path is created from “Server 1” to the established VLU1 via “SAN Switch 1”, and the secondary path to LU1 is removed. In FIG. 30(d), a secondary path is added between “Server 1” and VLU1 via “SAN switch 1”.

Some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example implementations, the steps carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A computer program, comprising:
a code for managing a server, a switch, and a storage system storing data sent from the server via the switch;
a code for calculating a plurality of elements among a plurality of element types, the plurality of elements comprising an element of at least one of the server, the switch and the storage system that can be affected by an event;
a code for calculating a condition for monitoring the calculated elements; and
a code for initiating monitoring of the calculated elements based on the calculated condition.

2. The computer program of claim 1, wherein the code for calculating the plurality of elements among the plurality of element types comprises code for, upon occurrence of the event, selecting the plurality of elements from the plurality of element types based on the event and information indicative of a relationship between the plurality of element types and one or more events.

3. The computer program of claim 2, wherein the information indicative of the relationship between the plurality of element types and one or more events comprises a failover method, and wherein the plurality of elements is selected based on the failover method.

4. The computer program of claim 1, wherein the event comprises at least one of an occurrence of a failure, a shutdown, and a maintenance mode of at least one of the server, the switch and the storage system.

5. The computer program of claim 4, wherein the condition for monitoring is calculated based on the calculated elements and wherein the condition for monitoring is changed upon occurrence of the event, the condition for monitoring being indicative of a time to initiate and stop the monitoring of the calculated elements.

6. The computer program of claim 1, further comprising a code for providing a view of the calculated elements, the view comprising performance information and topology information of the server, the switch and the storage system.

7. A computer, comprising:
a processor, configured to:
manage a server, a switch, and a storage system storing data sent from the server via the switch;
calculate a plurality of elements among a plurality of element types, the plurality of elements comprising an element of at least one of the server, the switch and the storage system that can be affected by an event;
calculate a condition for monitoring the calculated elements; and
initiate monitoring of the calculated elements based on the calculated condition.

8. The computer of claim 7, wherein the processor is configured to calculate the plurality of elements among the plurality of element types by, upon occurrence of the event, selecting the plurality of elements from the plurality of element types based on the event and information indicative of a relationship between the plurality of element types and one or more events.

9. The computer of claim 8, wherein the information indicative of the relationship between the plurality of element types and one or more events comprises a failover method, and wherein the processor is configured to select the plurality of elements based on the failover method.

10. The computer of claim 7, wherein the event comprises at least one of an occurrence of a failure, a shutdown, and a maintenance mode of at least one of the server, the switch and the storage system.

11. The computer of claim 10, wherein the processor is configured to calculate the condition for monitoring based on the calculated elements and wherein the processor is configured to change the condition for monitoring upon occurrence of the event, the condition for monitoring being indicative of a time to initiate and stop the monitoring of the calculated elements.

12. The computer of claim 7, wherein the processor is further configured to provide a view of the calculated elements, the view comprising performance information and topology information of the server, the switch and the storage system.

13. A system, comprising:
a server;
a switch;
a storage system; and
a computer configured to:
manage the server, the switch, and the storage system storing data sent from the server via the switch;
calculate a plurality of elements among a plurality of element types, the plurality of elements comprising an element of at least one of the server, the switch and the storage system that can be affected by an event;
calculate a condition for monitoring the calculated elements; and
initiate monitoring of the calculated elements based on the calculated condition.

14. The system of claim 13, wherein the computer is configured to calculate the plurality of elements among the plurality of element types by, upon occurrence of the event, selecting the plurality of elements from the plurality of element types based on the event and information indicative of a relationship between the plurality of element types and one or more events.

15. The system of claim 14, wherein the information indicative of the relationship between the plurality of element types and one or more events comprises a failover method, and wherein the computer is configured to select the plurality of elements based on the failover method.

16. The system of claim 13, wherein the event comprises at least one of an occurrence of a failure, a shutdown, and a maintenance mode of at least one of the server, the switch and the storage system.

17. The system of claim 16, wherein the computer is configured to calculate the condition for monitoring based on the calculated elements and wherein the computer is configured to change the condition for monitoring upon occurrence of the event, the condition for monitoring being indicative of a time to initiate and stop the monitoring of the calculated elements.

18. The system of claim 13, wherein the computer is further configured to provide a view of the calculated elements, the view comprising performance information and topology information of the server, the switch, and the storage system.
